(19) United States
(12) Patent Application Publication
(10) Pub. No.: US 2024/0103144 A1
(43) Pub. Date: Mar. 28, 2024

(54) DETECTION METHOD AND DETECTION SYSTEM FOR ACQUIRING DISTANCE INFORMATION

(71) Applicant: Ningbo ABAX Sensing Electronic Technology Co., Ltd., Ningbo City (CN)

(72) Inventor: Shuyu LEI, Ningbo City, Zhejiang Province (CN)

(73) Assignee: Ningbo ABAX Sensing Electronic Technology Co., Ltd., Ningbo City, ZH (CN)

(21) Appl. No.: 18/274,245

(22) PCT Filed: Dec. 22, 2021
(86) PCT No.: PCT/CN2021/140482

§ 371 Date: Jul. 26, 2023

(30) Foreign Application Priority Data
Jan. 26, 2021 (CN) 202110103547.4

(51) Int. Cl. G01S 7/4915; G01S 7/481; G01S 17/36

(52) U.S. Cl. CPC G01S 7/4915; G01S 7/4815; G01S 17/36

(57) ABSTRACT

The disclosure provides a detection method for acquiring distance information, which is performed by a distance detection system including a light emitting module, a processing module and a light receiving module; the detection method including: the light emitting module emits light signals with different emitted frequencies; the light receiving module obtains returned light signal which is the emitted light reflected by detected object in the field of view, and converts the returned light signal into electrical signal; and the processing module acquires the distance information of the detected object according to the electrical signal converted from the returned light signal acquired by the receiving module, wherein the processing module includes at least two sets of conversion relationships for calculating the distance information from the electrical signal, the processing module acquires the distance information of the detected object according to one of the conversion relationships.

### CROSS REFERENCE TO RELATED APPLICATIONS

The present application claims priorities to Chinese Patent Application No. 202110103547.4, titled “DETECTION METHOD AND DETECTION SYSTEM FOR ACQUIRING DISTANCE INFORMATION”, filed on Jan. 26, 2021 with the Chinese Patent Office, all of which are incorporated herein by reference in their entireties.

### FIELD

The present disclosure relates to the technical field of distance acquisition systems, and in particular to a detection method and detection system for acquiring distance information.

### BACKGROUND

Time-of-flight (TOF) technology was developed as a method of measuring the distance to an object in a scene. This TOF technology can be applied in various fields, such as automotive industry, human-machine interface, gaming, robotics and security, etc. Generally speaking, TOF technology works by illuminating a scene with modulated light from a light source (often referred to as emitted light) and observing the reflected light (often referred to as return light) reflected by objects in the scene. In the existing detection system, in order to achieve a higher detection efficiency during the detection process and also to ensure that the detection system has a wider field of view, an array-type receiving module is currently used. Thousands of pixel units are arranged in the array-type receiving module, wherein each pixel unit may be a diode of a charge-coupled semiconductor CCD or a complementary metal oxide semiconductor CMOS type, etc. Here is illustrative only and does not restrict the types of pixel units that make up an array-type receiving module.

In order to acquire the distance information, in the process of using the TOF technology for detection, the delay information of the emitted light and the returned light is obtained first, then the delayed phase (also known as phase offset) is obtained, and then the phase offset is converted into the final distance information, this method converts the distance information of the detected object into the phase shift of the returned light and the emitted light instead of giving the distance result directly. This scheme is called indirect time-of-flight ranging (ITOF). In actual use, the complementary phase can be used to receive the returned optical signal, and then the distance information can be obtained. This method is called a two-phase scheme. There are also schemes to obtain the target distance using four phases 0°, 90°, 180° and 270°. Of course, there are schemes attempt to obtain the target distance by using a 3-phase scheme or even a 5-phase scheme in the prior art. After the phase-shifted electrical signal is obtained, a processing module processes the electrical signal to obtain final distance information. However, actually obtaining the electrical signal corresponding to the returned optical signal may be affected by environmental factors, including but not limited to temperature and ambient lighting conditions. For example, temperature changes in the sensor array can increase the so-called dark current of the pixel, which in turn can change the phase offset of the measurement, so the measurement results will show large distance fluctuations, while the actual detection emitted light has a high frequency such as 20 MHz, 40 MHz, 80 MHz, etc., plus the time of data transmission and data processing, dozens of detection results can be obtained within 1 s, such as higher than the human eye that 30 times result refresh can distinguish under static conditions, in some special scenarios, the refresh frequency of the distance will be higher, such as 120 times and so on. In this case, for an object with a constant position, the distance result of the signal which is converted by the signal that transmitted by the sensor array is changing, so a specific conversion relationship is required to eliminate the influence of the aforementioned dark current to obtain an accurate detection distance. However, the distance information corresponding to the phase near the phase boundary points such as 0° and 360°, the distance result caused by this fluctuation is catastrophic, and the error may reach 200% or even greater. It would be unacceptable, and in terms of autonomous driving technology, for example, such huge errors often bring huge safety risks.

Based on the above mentioned analysis, it is an urgent technical problem to design a detection method and detection system for acquiring distance information to accurately and stably output the stable and accurate distance results of the detected objects within each distance range in the field of view.

### SUMMARY

In view of this, a detection method and detection system for acquiring distance information is provided in the present disclosure, which can accurately and stably output stable and accurate distance results of the detected objects within each distance range in the field of view.

Technical solutions in embodiments of the present disclosure are provided as follows:

In a first aspect, a detection method for acquiring distance information is provided according to an embodiment of the present disclosure. The detection method is performed by a distance detection system including a light emitting module, a processing module and a light receiving module; the detection method including:
the light emitting module emits light signals with different emitted frequencies;
   the light receiving module obtains returned light signal which is the emitted light reflected by detected object in the field of view, and converts the returned light signal into electrical signal;
   and the processing module acquires the distance information of the detected object according to the electrical signal converted from the returned light signal acquired by the receiving module, wherein the processing module includes at least two sets of conversion relationships for calculating the distance information from the electrical signal, the processing module acquires the distance information of the detected object according to one of the conversion relationships.

In an embodiment, the light emitting module emits at least two groups of emitted light signals with different emitted frequencies, and the frequencies of at least one group of the emitted light are related to the distance accuracy of the detection system.

In an embodiment, the emitted light further includes a second emitted light with a frequency lower than the frequency of the emitted light determined by the distance accuracy.

In an embodiment, the processing module outputs the final target distance information according to the returned light signal of the second emitted light and the returned light signal of the emitted light determined by the distance accuracy.

In an embodiment, the processing module acquires the distance information of the detected object based on the electrical signal corresponding to the returned light of the emitted light determined by the distance accuracy and/or the corresponding second emitted light, according to one of the conversion relationship.

In an embodiment, the distance information acquired according to one of the conversion relationships, based on the electrical signal converted by the returned light corresponding to the emitted light is fluctuated, when the fluctuation of the distance information exceeds a preset value, the processing module outputs the distance information converted by the electrical signal according to another conversion relationship of the at least two sets of conversion relationships.

In one embodiment, the emitted light further includes at least one set of emitted lights with a frequency less than the emitted frequency of the second emitted light.

In an embodiment, the emitted light further includes multiple groups of emitted lights with a frequency lower than the emitted frequency of the second emitted light, and the multiple groups of emitted lights with the frequency lower than the emitted frequency of the second emitted light achieve the frequency of the second emitted light by arranged according to at least one of the following rules: arithmetic progression, arithmetic progression, Rosin distribution, and so on.

In one embodiment, the at least two sets of conversion relationships are functional relationships with phase offset relationships.

In one embodiment, the phase offset relationship is expressed as f₂ (φₓ)=f₁ (φₓ)+d (θ).

In one embodiment, the phase offset relationship is expressed as: f₂ (φₓ)=f₁ (ωₓ+β)+d (θ).

In an embodiment, the processing module converts the electrical signal converted by the returned light to obtain delay phase information, and when the distance fluctuation obtained by the delay phase according to one of the functional relationship is greater than the preset value, the processing module outputs the corrected phase delay signal converted from the electrical signal according to another functional relationship of the at least two sets of conversion relationships, and then uses the corrected phase delay signal to acquire the calculated precision-related distance result.

In an embodiment, the processing module converts the electrical signal converted from the returned light of the precision-related emitted light and the second emitted light to obtain the delay phase information, and judges the distance fluctuation, which the distance acquired form the returned light of the two different frequencies of emitted light according to one of the conversion relationship, when the distance fluctuation is greater than the preset value, the processing module outputs the corrected phase delay of the electrical signal converted from the electrical signal according to another functional relationship of the at least two sets of conversion relationships, and then use the corrected phase delay signal to acquire the calculated precision-related distance result.

In a second aspect, a detection system is provided according to an embodiment of the present disclosure, to perform the detection method described in the first aspect above. The detection system includes:
a light emitting module, for emitting emitted light signals with different emitted frequencies;
a light receiving module, for obtaining returned light signal which is the emitted light reflected by detected object in the field of view, and converts the returned light signal into electrical signal;
and a processing module, for acquiring the distance information of the detected object according to the electrical signal converted from the returned light signal acquired by the receiving module, wherein the processing module includes at least two sets of conversion relationships for calculating the distance information from the electrical signal, the processing module acquires the distance information of the detected object according to one of the conversion relationships.

In an embodiment, the light emitting module emits at least two groups of emitted light signals with different emitted frequencies, and the frequencies of at least one group of the emitted light are related to the distance accuracy of the detection system.

In an embodiment, the emitted light further includes a second emitted light with a frequency lower than the frequency of the emitted light determined by the distance accuracy.

In an embodiment, the processing module outputs the final target distance information according to the returned light signal of the second emitted light and the returned light signal of the emitted light determined by the distance accuracy.

In an embodiment, the processing module acquires the distance information of the detected object based on the electrical signal corresponding to the returned light of the emitted light determined by the distance accuracy and/or the second emitted light, according to one of the conversion relationship.

In an embodiment, the distance information acquired according to one of the conversion relationships, based on the electrical signal converted by the returned light corresponding to the emitted light is fluctuated, when the fluctuation of the distance information exceeds a preset value, the processing module outputs the distance information converted by the electrical signal according to another conversion relationship of the at least two sets of conversion relationships.

In an embodiment, the processing module converts the electrical signal converted from the precision-related emitted light and the returned light of the second emitted light to obtain the delay phase information, and judges the distance fluctuation, which the distance acquired form the returned light of the two different frequencies of emitted light according to one of the conversion relationship, when the distance fluctuation is greater than the preset value, the processing module outputs the corrected phase delay of the electrical signal converted from the electrical signal according to another functional relationship of the at least two sets of conversion relationships, and then use the corrected phase delay signal to acquire the calculated precision-related distance result.

The beneficial effect of this discourse is:

According to the detection method for acquiring distance information provided in the embodiment of the present disclosure. The detection method is performed by a detection system including a light emitting module, a processing module and a light receiving module. The detection method including: the light emitting module emits light signals with different emitted frequencies; the light receiving module obtains returned light signal which is the emitted light reflected by detected object in the field of view, and converts the returned light signal into electrical signal; and the processing module acquires the distance information of the detected object according to the electrical signal converted from the returned light signal acquired by the receiving module, wherein the processing module includes at least two sets of conversion relationships for calculating the distance information from the electrical signal, the processing module acquires the distance information of the detected object according to one of the conversion relationships. Through the scheme of the present disclosure, on the one hand, at least two sets of conversion relationships are set in the processing module of the detection system, and the processing module acquires the final distance information according to one of the conversion relationships, which can achieve adaptation to different fields of view to ensure different range detections. The detection system at different distance ranges can obtain distance data efficiently and accurately. In some special distance ranges, the result of distance information itself fluctuates greatly, by switching between at least two sets of conversion relationships, accurate results for different distances ranges in the field of view are achieved with little external and internal influence.

### BRIEF DESCRIPTION OF THE DRAWINGS

In order to illustrate technical solutions of embodiments of the present disclosure more clearly, the drawings used for the embodiments are briefly introduced in the following. It should be understood that the drawings show only some embodiments of the present disclosure, and should not be regarded as a limitation of the scope. Other drawings may be obtained by those skilled in the art from these drawings without any creative work.

FIG. 1 is a schematic diagram showing working principle of a detection system according to an embodiment of the present disclosure;

FIG. 2 is a schematic diagram of obtaining a time-of-flight signal in ITOF according to the prior art;

FIG. 3 is a schematic diagram of an actual distance and a detection phase offset result according to an embodiment of the present disclosure;

FIG. 4A is a schematic diagram of phase shift results corresponding to optical signals returned from different positions according to an embodiment of the present disclosure;

FIG. 4B is a schematic diagram of repetition of a phase shift result at a boundary position according to an embodiment of the present disclosure;

FIG. 5 is a schematic diagram of phase offset fluctuation results at different positions according to an embodiment of the present disclosure;

FIG. 6A is a schematic diagram of conversion of at least two sets of conversion relationships according to an embodiment of the present disclosure;

FIG. 6B is another schematic diagram of conversion of at least two sets of conversion relationships according to an embodiment of the present disclosure;

FIG. 7A is a schematic diagram of a detection result error without using the correction method according to an embodiment of the present disclosure;

FIG. 7B is a schematic diagram of another detection result error without using the correction method according to an embodiment of the present disclosure;

FIG. 7C is a schematic diagram of the detection result error with using the correction method according to an embodiment of the present disclosure;

FIG. 7D is a schematic diagram of another detection result error with using the correction method according to an embodiment of the present disclosure.

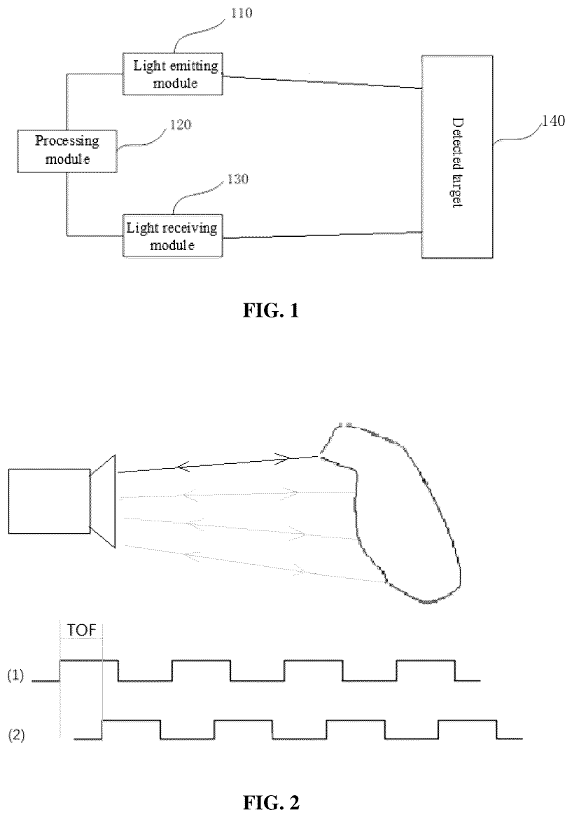

### DETAILED DESCRIPTION OF EMBODIMENTS

In order to make objects, technical solutions and advantages of the embodiments of the present disclosure clearer, the technical solutions in the embodiments of the present disclosure are clearly and completely described below with reference to the drawings in the embodiments of the present disclosure. Apparently, the described embodiments are some but not all embodiments of the present disclosure. Components of the embodiments generally described and illustrated in the drawings herein may be arranged and designed in a variety of different configurations.

Therefore, the following detailed description for the embodiments of the present disclosure provided in the drawings is not intended to limit the scope of the present disclosure as claimed, but is merely representative of selected embodiments of the present disclosure. Based on the embodiments in the present disclosure, all other embodiments obtained by those skilled in the art without creative work shall fall in the protection scope of the present disclosure.

It should be noted that, similar numerals and letters refer to similar items in the following drawings. Therefore, if an item is defined in a drawing, the item is not required to be further defined and explained in subsequent drawings.

The detection system currently used basically includes: the light emitting module, the processing module, and the light receiving module. ITOF ranging as an example for description here, the light source includes but is not limited to a semiconductor laser and/or a solid-state laser, and may include other types of lasers. In a case that a semiconductor laser is used as the light source, a vertical-cavity surface-emitting laser VCSEL (Vertical-cavity surface-emitting laser) or an edge-emitting semiconductor laser EEL (edge-emitting laser) can be used, which is only exemplary and is not limited herein. Further, the waveform of the light outputted by the light source may be a square wave, a triangular wave, a sine wave, or the like, which is generally implemented as a laser with a certain wavelength in the distance measurement application, such as an infrared laser of 950 nm and other infrared lasers (optimally near-infrared lasers). The emitted light is projected into a view field, and a detected object in the view field may reflect the projected laser light to form a return light. The return light enters the detection system and is received by the light receiving module. The light receiving module may include a photoelectric conversion section, such as an array sensor formed by CMOS or CCD. The light receiving module may further include multiple lenses to form one or more image planes, that is, the light receiving module contains one or more image planes. The photoelectric conversion section of the light receiving module is located at one of the image planes, which may receive delay receiving signals of 0°, 90°, 180° and 270° with the most common four-phase solution. The four-phase distance calculation solution is illustrated herein by taking the sine wave as an example. The amplitude of the received signal is measured at four equally spaced points (for example, 90° or at a (¼)λ interval). The distance calculation formula of the four-phase distance measurement is shown as follows.

$$φ = ArcTan ( \frac{{A}_{1} - {A}_{3}}{{A}_{2} - {A}_{4}} ) \qquad ( 1 )$$

A ratio of a difference between A₁ and A₃ to a difference between A₂ and A₄ is equal to the tangent of the phase angle. ArcTan is actually a bivariate inverse tangent function that can be mapped to the appropriate quadrant, and defined as 0° or 180° in the case of A₂=A₄ and A₁>A₃ or A₃>A₁, respectively.

The distance to the object is determined by the following equation:

$$d = \frac{c \cdot φ}{4 π \cdot f} \qquad ( 2 )$$

Further, the frequency of the emitted laser is required to be determined to perform the distance measurement, where c represents the light speed, φ represents a phase angle (measured in radians), and f represents a modulation frequency. The above scheme can achieve the effect of distance detection for the detected object in the field of view, and this scheme is called the four-phase delay scheme to obtain the detection result. Of course, the photoelectric conversion of the receiving module generates different information. In some cases, the 0° and 180° two-phase scheme is used to obtain the information of the detected object. In addition, the acquisition of the target information by the 0°, 120° and 240° three-phase solution is disclosed in some documents, and a five-phase delay solution is disclosed in even some documents, which is not specifically limited in the present disclosure. In actual measurement, a square wave is also used for detection. The mechanism is similar to that of a sine wave, but the calculation formula is different and will not be described in detail here.

FIG. 2 is a schematic diagram showing the emitted wave is a square wave. The detection system emits emitted light, and different regions indicate different emitted light colors. In actual, the emitted light can be uniform light or non-uniform light, which is not limited here, but the actual wavelength of the emitted light changes is small, which does not reflect the color difference, in addition, the actually used emitted light is an infrared laser with higher safety for human eyes, and its wavelength can be in the range of 900 nm to 1000 nm, which is not limited here. The emitted light is reflected by the detected object to form the returned light. FIG. 2 shows the phase shift between the emitted light (1) and the returned light (2), which actually represents the distance-dependent time-of-flight phase shift, the range information can be obtained as long as the phase offset can be obtained.

FIG. 3 is a schematic showing the relationship between phase information converted by returned light of the emitted light and true distance information. The light source used in the active detection system always has low emission power, with peak power in the order of hundreds of mill watts to several watts, and the laser emission frequency can be set according to different situations and different accuracy requirements. for example, from 20 MHz to hundreds of MHz, different laser emission frequencies usually correspond to different detection accuracy. 25 MHz belongs to low-frequency detection, and its accuracy is low, but the farthest distance that can be detected in one cycle is relatively far. for example, the farthest detection distance is 6 m according to the time-of-flight scheme, for a laser with hundreds of MHz, such as 120 MHz, the farthest detection distance is only 1.25 m according to the time-of-flight scheme, for different distance range, the difference of distance precision is nearly 5 times. The general detection system has certain requirements for the detection range and detection accuracy. For example, the situation in the general field of view is complicated, the detection system needs to detect a longer distance, and for different distance information the application scenario of the system requires the detection system to achieve higher precision to obtain more accurate scenarios. So detection schemes with two or more frequencies are proposed, among which the highest frequency detection laser often corresponds to higher accuracy, for example, the combined results of high frequency and low frequency results can be used, for example, the scheme of finding the common multiple of the high frequency and low frequency can obtain the final distance information. Or another method can be used, first use different low-frequency emitted lights to detect the approximate position of the object, and then use a caliper-like scheme in a small range to obtain the final precise distance information by precision-related high frequency, which is not limited to the method used to achieve the final solution that takes into account a wide range and accuracy to acquire the distance result. The phase shift shows a positive correlation with the real distance result, that the phase shift calculated by the electrical signal converted by the returned light which is the emitted light returns from the detected object, but as shown in FIG. 3 that the obtained phase shift is not completely reflects the real distance information of the detected object. This difference mainly comes from the following influences: 1. The influence of the electrical characteristics caused by the internal structure and defects of the sensor; 2. Higher-order term effects introduced by the defects of the light source emitter emission waveform itself. Therefore, in order to obtain the real results of phase and distance, the present disclosure is based on the assumption of linear correspondence, so that there are at least two sets of conversion relationships between the electrical signal converted by the returned light and the distance result, as shown in the following equation (3) and equation (4):

dₗᵢₙₑₐᵣ₋₁=f₁(p_{x-draw-nonlinear}) (3)

dₗᵢₙₑₐᵣ₋₂=f₂(p_{x-draw-nonlinear}) (4)

In this way, a one-to-one correspondence between the phase offset converted by the electrical signal and the actual distance result can be obtained, and the detection result can also more accurately represent the actual distance.

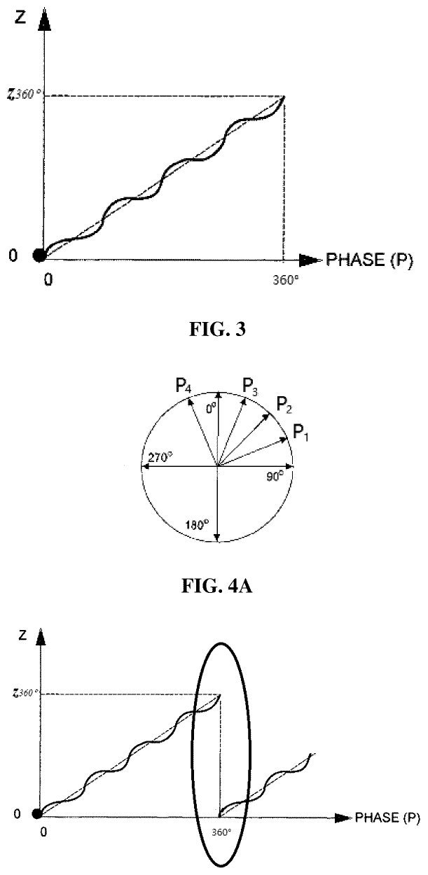

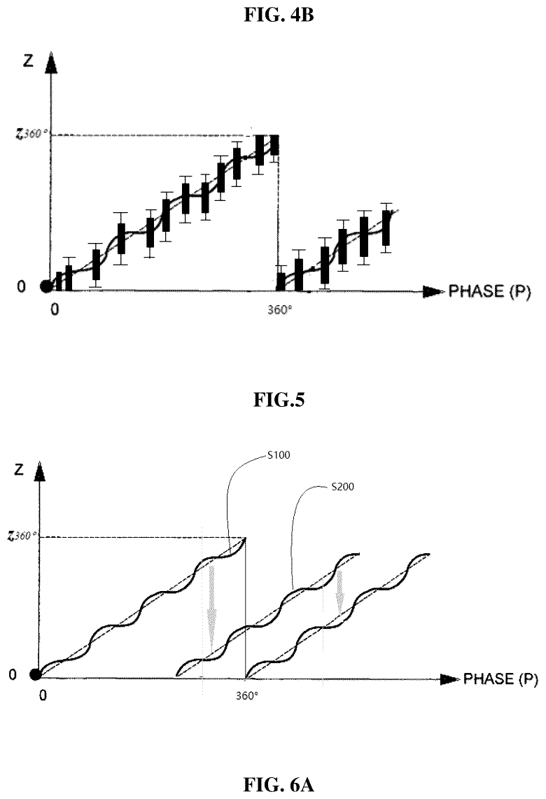

Most of the results described above in one cycle, that is, in the range of 0-360°, are fitted according to one of the above relationships, and more accurate detection results and detection result data corresponding to phase offsets can be obtained. However, in actual detection of objects The distance to the detection system is uncertain, as shown in FIG. 4A and FIG. 4B, of course, due to the influence of the shape and contour of the detected object, the detection result is also in an uncertain range. For example, the phase shift converted by the returned light may be any one of P 1, P 2, P 3 and P 4 etc. which may also correspond to different locations in the relationship of distance and phase offset. More troublesome, is that the actual phase signal is repeated, such as the corresponding detection results are same and cannot be distinguished for 2kπ+P 1 with P 1. For this problem, some scholars have proposed a dual-frequency or multi-frequency detection scheme. One way is to use two or more sets of detection frequencies for the same detected target, obtain the least common multiple of two or more of them, so that the detection distance can be extended. However, in this method, the difference between the two detection frequencies taking the common multiple should not be too large, and one frequency can be set to be in the range of 60% to 90% of the another frequency, and the highest detection frequency can correspond to the detection precision that needs to be guaranteed. Another solution is to use different lower frequencies to first obtain a rough object distance, and then obtain the detection result of the highest frequency by controlling the solution such as the integration time window, so that the detection result with high precision can also be obtained. For example, the distance of the detected target object is 1.35 m, so it can be determined that the accuracy of the detection result is within 0.01 m. According to this accuracy requirement, the highest emission frequency of the detector related to the accuracy can be selected, and the frequency of emission light is lower than the frequency of precision-related emission light is called the emission light of the first emission frequency, and it can be arranged according to any of the above two schemes, for example the emitted light of the first emission frequency can be determined according to the farthest detection distance, of course, the emitted light of second emission frequency which lower than the first emission frequency can be set corresponds to the farthest detection distance, also there may be multiple detection frequencies between the first frequencies and the second frequencies, and each detection frequency is arranged according to at least one of arithmetic progression, geometric progression, Rosin distribution, etc., so that a more accurate positioning can be obtained, so as to obtain a more accurate detection distance range for the highest frequency detection result corresponding to the subsequent accuracy, and it is also conducive to quickly and efficiently obtain the distance result that finally achieves the detection accuracy requirements. Of course, the final results can be obtained in different ways in the processing module. The first is to process the distance results corresponding to the accuracy and the results of lower transmission frequencies to obtain the final and most accurate distance results, the other is to process the distance results of different frequencies in different time periods, and the low-frequency detection results have been considered when the processing module obtains the final accuracy-related frequency detection results, at this time, the final distance result that satisfies the accuracy requirement can be acquired directly in the processing of electrical signal converted by the returned light that corresponding to the highest-frequency emission light.

However, in the process of real-time detection, due to the high emission frequency of the emitted light, which was also described before, the number of detections that can be arranged per second can be many, for example, in order to ensure the refresh rate higher than the refresh rate that the eyes can distinguish in the case of concentration, that the refresh rate that the eyes can distinguish in the case of concentration is 30 fps, and the refresh rate of the detection result of the detection system also needs to be higher than 30 fps. Some special scenarios even require a refresh rate of 60 fps or even 120 fps, so the distance results acquired by the detection system will also be multiple groups as shown in FIG. 5, the influencing factors of the converted phase have been analyzed before, that is to say, there is fluctuation in the result for the same detection target each time. This fluctuation can be eliminated in most cases by using the conversion relationship between the previous phase and the real distance, then a stable output of the distance result value is acquired. However, in a special scenario near the phase of 0° and 360° as shown in FIG. 5, the result error caused by this fluctuation will be unacceptable, for example the result of a certain detection, its phase offset is 353°, and in some detection results for the same detection target the detection results may be 5°, −8°, etc., so the difference of distance converted from the phase offset is actually huge. The difference will actually lead to the failure of detection, because this amplitude change will be fatal interference for controlling or other application scenarios, and the detected distance will also be uncertain at this time.

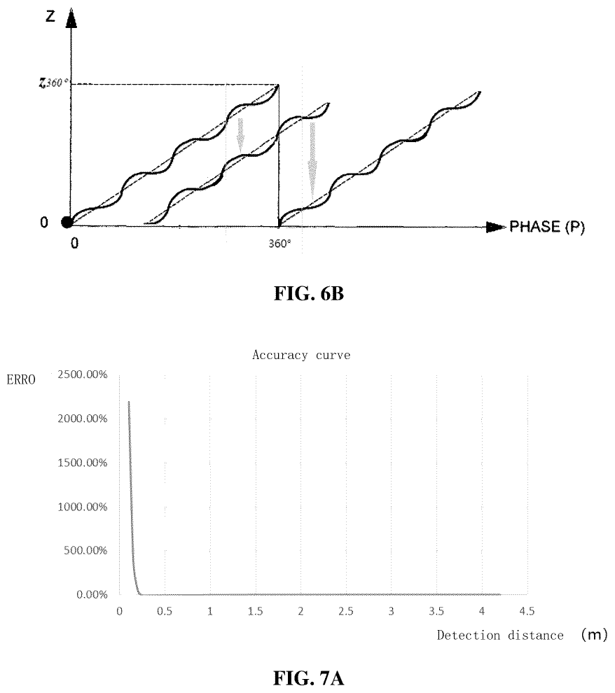

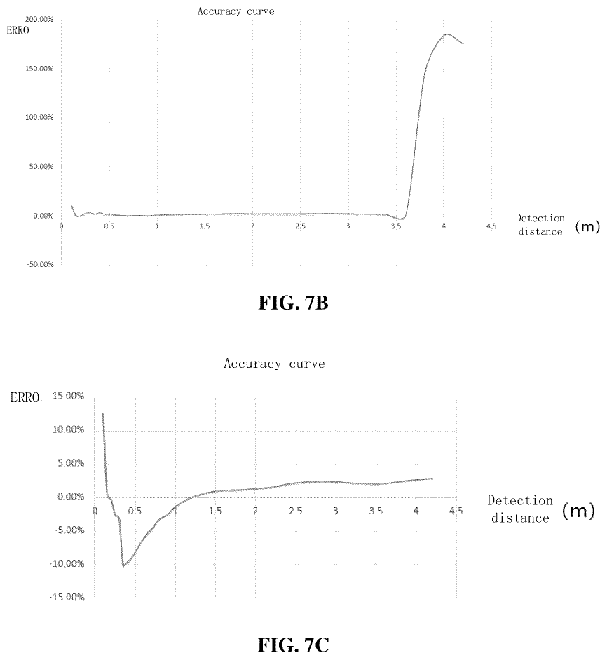

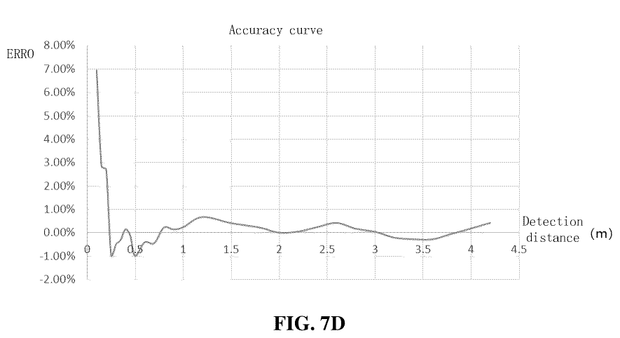

Combined with the analysis of the two actual detection results as shown in FIG. 7A and FIG. 7B, the reason for the uncertainty of detection distance at the critical phase is explained in FIG. 5. In these two groups of results, FIG. 7A is a schematic diagram of the large difference between the distance detected by the close detector and the actual object, it can be seen that the error of the distance acquired by the detector at some positions and the actual object distance exceeds 100%, the distance acquired by the detect system and the actual error can be controlled within an acceptable range with the distance continuously moving back. FIG. 7B is a schematic diagram of a large error occurring at the maximum detection range of a certain detection frequency. Similarly, closer to the maximum detection range value, the distance error given by the detect system also exceeds 100%, that is, the distance detection fails completely. In order to solve this technical problem, this disclosure provides a scheme that includes at least two conversion relationships between phase offsets and real distances inside the processor. The two conversion relationships can be the linear relationship described in the previous formula (3) and formula (4), further, there is a phase offset relationship between the two conversion relationships, for example, there may be a translation relationship on the abscissa between the first conversion relationship S100 shown in FIG. 6A and the second conversion relationship, that is, there is a corresponding relationship as shown in formula (5):

f₂(φₓ)=f₁(φₓ+β) (5)

Of course, there may be a translation relationship on the abscissa between the first conversion relationship and the second conversion relationship as shown in FIG. 6A, as shown in formula (6):

f₂(φₓ)=f₁(φₓ)+d(θ) (6)

Further, the relationship between the first conversion relationship and the second conversion relationship can be established through translation on the horizontal and vertical coordinates, as shown in formula (7):

f₂(φₓ)=f₁(φₓ+β)+d(θ) (7)

The above scheme shows the relationship between the two conversion relationships. The relationship between the two conversion relationships can be established by simple translation, etc., which can ensure that the reliability of the calculation achieves the requirements, through smaller and simpler data storage and the data correction scheme to obtain the final result, so that the existing detector framework need not be changed, and only changes on the algorithm side can acquire high-precision distance detection results, so as to achieve the effect of acquiring the most accurate distance results at the least cost. The phases β and θ is determined between the above-mentioned translation conversion relationship can select different values according to the usage conditions, for example, select the values between π/3 and 2π/3. In actual use, the values can be pre-selected and preset in the processing module, also a specific conversion relationship can be generated according to the actual scene association, and the implementation manner and specific values are not limited here.

As shown in FIG. 6A and FIG. 6B, the processing module first processes the detection results of different phase offsets by the corresponding relationship of S100, and acquires accurate and stable distance information by conversion. As the offset phase increases, when the offset phase approaches the critical phase offset, the preset value of the phase offset range can be used, for example, within 10%, that is, within the 36° range close to the critical phase, or the automatic triggering scheme can be used, when the error of multiple range detection results is more than the preset value of the fluctuation, such as triggering when the fluctuation exceeds 20% of the preset value, in using any one scheme, when there is a need to switch the conversion function relationship, the processor switches the conversion function relationship to S200 to acquire the final distance information output result, when there is any of the aforementioned conversion conditions in the conversion relationship application of S200, the phase distance corresponding relationship S200 can be switched back to the function conversion relationship S100, so that stable and accurate detection result for different distances can be acquired by the repetition of switching between S100 and S200. Of course in multi-frequency ranging, the detection results of each frequency can be acquires by the above method, and then the stable and accurate detection results with the accuracy achieving the requirements can be acquired. When the fluctuation of the distance result automatically controls system to detect, the processing module acquires delay phase information by converting the electrical signal which converted from the precision-related emitted light and the returned light of the second emitted light, determines the distance fluctuation for the returned light of the two different frequencies emitted light according to one conversion relationship, when the distance fluctuation is greater than the preset value, the processing module outputs the corrected phase delay signal converted from the electrical signal according to another conversion relationship of the at least two sets of the conversion relationships, and then acquires the calculated accuracy-related distance results by the corrected phase delay signal. Of course, also can firstly acquire the accuracy-related first distance results by the corrected phase delay signal, and then acquires the final accuracy-related precise distance results through the correction coefficients. Of course, the above method is only an example to describe the switching way applicable to the process of system detection and the different conversion functions, which is not limited here. For example, other switching conditions can be stored in the processing module, so as to realize switching between different conversion relationships.

FIG. 7C is a schematic diagram of the distance error between the detection result of different detection distances acquired according to the embodiment of the present disclosure and the actual object distance. From FIG. 7C, it can be known that within the range of different detection distances, even if the turning phase is close to 0° at a close distance or is close to 360°, the detection system of the present disclosure can provide the distance information results that achieves the requirements, the maximum error is also within the range of 15%, and there is absolutely no error that exceeds 100% which causes detection failure as shown in FIG. 7A and FIG. 7B, this result will also have huge advantages in the application of various actual scenarios, and can provide solutions that achieve the requirements of precision detection range and accuracy, and the detection accuracy in most scenarios can be controlled within 5% error range.

FIG. 7D is another schematic diagram of the distance error between the detection result of different detection distances acquired according to the embodiment of the present disclosure and the actual object distance. The difference between FIG. 7C and FIG. 7B is that there is difference between the corresponding second correction relationship and the phase offset relationship of the original signal. The higher-precision detection results can be acquired by adjusting the appropriate offset relationship, and the accuracy of detection results can be higher under more optimal conditions. In most distance ranges, the error can be controlled within the fluctuation range of 1%, the specific parameter range is not limited here.

It should be noted that the terms “including”, “comprising” or any other variation thereof are intended to encompass a non-exclusive inclusion such that a process, method, article or device comprising a series of elements includes not only those elements, but also no other elements expressly listed, or which are also inherent to such a process, method, article or apparatus. Without further limitation, an element qualified by the phrase “comprising a . . . ” does not preclude the presence of additional identical elements in a process, method, article or apparatus that includes the element.

The above descriptions are only preferred embodiments of the present disclosure, and are not intended to limit the present application. For those skilled in the art, the present disclosure may have various modifications and changes. Any modification, equivalent replacement, improvement, etc. made within the spirit and principle of this application shall be included within the protection scope of this application. It should be noted that like numerals and letters refer to like items in the following figures, so once an item is defined in one figure, it does not require further definition and explanation in subsequent figures. The above descriptions are only preferred embodiments of the present disclosure, and are not intended to limit the present application. For those skilled in the art, the present application may have various modifications and changes. Any modification, equivalent replacement, improvement, etc. made within the spirit and principle of this application shall be included within the protection scope of this application.

1. 1. A detection method for acquiring distance information is performed by a distance detection system including a light emitting module, a processing module and a light receiving module; the detection method including:
the light emitting module emits light signals with different emitted frequencies;
the light receiving module obtains returned light signal which is the emitted light reflected by detected object in the field of view, and converts the returned light signal into electrical signal;
and the processing module acquires the distance information of the detected object according to the electrical signal converted from the returned light signal acquired by the receiving module, wherein the processing module includes at least two sets of conversion relationships for calculating the distance information from the electrical signal, the processing module acquires the distance information of the detected object according to one of the conversion relationships.

2. The detection method for acquiring distance information according to claim 1, wherein the light emitting module emits at least two groups of emitted light signals with different emitted frequencies, and the frequencies of at least one group of the emitted light are related to the distance accuracy of the detection system.

3. The detection method for acquiring distance information according to claim 2, wherein the emitted light further includes a second emitted light with a frequency lower than the frequency of the emitted light determined by the distance accuracy.

4. The detection method for acquiring distance information according to claim 3, wherein the processing module outputs the final target distance information according to the returned light signal of the second emitted light and the returned light signal of the emitted light determined by the distance accuracy.

5. The detection method for acquiring distance information according to claim 3, wherein the processing module acquires the distance information of the detected object based on the electrical signal corresponding to the returned light of the emitted light determined by the distance accuracy and/or the corresponding second emitted light, according to one of the conversion relationship.

6. The detection method for acquiring distance information according to claim 5, wherein the distance information acquired according to one of the conversion relationships, based on the electrical signal converted by the returned light corresponding to the emitted light is fluctuated, when the fluctuation of the distance information exceeds a preset value, the processing module outputs the distance information converted by the electrical signal according to another conversion relationship of the at least two sets of conversion relationships.

7. The detection method for acquiring distance information according to claim 3, wherein the emitted light further includes at least one set of emitted lights with a frequency less than the emitted frequency of the second emitted light.

8. The detection method for acquiring distance information according to claim 7, wherein the emitted light further includes multiple groups of emitted lights with a frequency lower than the emitted frequency of the second emitted light, and the multiple groups of emitted lights with the frequency lower than the emitted frequency of the second emitted light achieve the frequency of the second emitted light by arranged according to at least one of the following rules: arithmetic progression, arithmetic progression, Rosin distribution, and so on.

9. The detection method for acquiring distance information according claim 1, wherein the at least two sets of conversion relationships are functional relationships with phase offset relationships.

10. The detection method for acquiring distance information according to claim 9, wherein the phase offset relationship is expressed as: f₂ (φₓ)=f₁ (φ_{c})+d (θ).

11. The detection method for acquiring distance information according to claim 10, wherein the phase offset relationship is expressed as:
f₂(φₓ)=f₁(φₓ+β)+d(θ).

12. The detection method for acquiring distance information according to claim 10, wherein the processing module converts the electrical signal converted by the returned light to obtain delay phase information, and when the distance fluctuation obtained by the delay phase according to one of the functional relationship is greater than the preset value, the processing module outputs the corrected phase delay signal converted from the electrical signal according to another functional relationship of the at least two sets of conversion relationships, and then uses the corrected phase delay signal to acquire the calculated precision-related distance result.

13. The detection method for acquiring distance information according to claim 3, wherein the processing module converts the electrical signal converted from the returned light of the precision-related emitted light and the second emitted light to obtain the delay phase information, and judges the distance fluctuation, which the distance acquired form the returned light of the two different frequencies of emitted light according to one of the conversion relationship, when the distance fluctuation is greater than the preset value, the processing module outputs the corrected phase delay of the electrical signal converted from the electrical signal according to another functional relationship of the at least two sets of conversion relationships, and then use the corrected phase delay signal to acquire the calculated precision-related distance result.

14. A detection system for acquiring distance information with the detection method of claim 1, wherein the detection system includes:
a light emitting module, for emitting emitted light signals with different emitted frequencies;
a light receiving module, for obtaining returned light signal which is the emitted light reflected by detected object in the field of view, and converts the returned light signal into electrical signal;
and a processing module, for acquiring the distance information of the detected object according to the electrical signal converted from the returned light signal acquired by the receiving module, wherein the processing module includes at least two sets of conversion relationships for calculating the distance information from the electrical signal, the processing module acquires the distance information of the detected object according to one of the conversion relationships.

15. The detection system for acquiring distance information according to claim 14, wherein the light emitting module emits at least two groups of emitted light signals with different emitted frequencies, and the frequencies of at least one group of the emitted light are related to the distance accuracy of the detection system.

16. The detection system for acquiring distance information according to claim 15, wherein the emitted light further includes a second emitted light with a frequency lower than the frequency of the emitted light determined by the distance accuracy.

17. The detection system for acquiring distance information according to claim 16, wherein the processing module outputs the final target distance information according to the returned light signal of the second emitted light and the returned light signal of the emitted light determined by the distance accuracy.

18. The detection system for acquiring distance information according to claim 16, wherein the processing module acquires the distance information of the detected object based on the electrical signal corresponding to the returned light of the emitted light determined by the distance accuracy and/or the second emitted light, according to one of the conversion relationship.

19. The detection system for acquiring distance information according to claim 18, wherein the distance information acquired according to one of the conversion relationships, based on the electrical signal converted by the returned light corresponding to the emitted light is fluctuated, when the fluctuation of the distance information exceeds a preset value, the processing module outputs the distance information converted by the electrical signal according to another conversion relationship of the at least two sets of conversion relationships.

20. The detection system for acquiring distance information according to claim 16, wherein the processing module converts the electrical signal converted from the precision-related emitted light and the returned light of the second emitted light to obtain the delay phase information, and judges the distance fluctuation, which the distance acquired form the returned light of the two different frequencies of emitted light according to one of the conversion relationship, when the distance fluctuation is greater than the preset value, the processing module outputs the corrected phase delay of the electrical signal converted from the electrical signal according to another functional relationship of the at least two sets of conversion relationships, and then use the corrected phase delay signal to acquire the calculated precision-related distance result.
